(19) United States
(12) Patent Application Publication
(10) Pub. No.: US 2012/0290981 A1
(43) Pub. Date: Nov. 15, 2012

(54) INFORMATION TERMINAL APPARATUS, OPERATION METHOD BY INFORMATION TERMINAL APPARATUS AND PROGRAM THEREOF

(75) Inventor: Kaoru Uchida, Tokyo (JP)

(73) Assignee: NEC CORPORATION, Tokyo (JP)

(21) Appl. No.: 13/522,028

(22) PCT Filed: Jan. 5, 2011
(86) PCT No.: PCT/JP2011/050050

§ 371 Date: Jul. 13, 2012

(30) Foreign Application Priority Data
Jan. 18, 2010 (JP) 2010-008391

(51) Int. Cl. G06F 3/048

(52) U.S. Cl. 715/810

(57) ABSTRACT

An information terminal apparatus is provided which presents an operation menu according to a target apparatus just by photographing the target apparatus by a built-in camera, thereby intuitively executing operation appropriate for the target apparatus. The information terminal apparatus includes a target recognition unit which recognizes a target apparatus from an image taken by photographing the apparatus by the built-in camera, a menu management unit which presents operation menu information preserved in advance according to the target apparatus based on a recognition result obtained by the target recognition unit, and a processing unit which gives an operation instruction according to operation contents selected based on the operation menu information.

### TECHNICAL FIELD

The present invention relates to an information terminal apparatus such as a cellular phone terminal and, more particularly, an information terminal apparatus capable of remote control of apparatuses such as home electric appliances, and an operation method and a program thereof.

### BACKGROUND ART

Some information terminal apparatuses such as a cellular phone terminal are provided with an infrared communication function which enables the apparatus to be used as a remote controller for such an apparatus as a home electric appliance or a radio communication function (e.g. Bluetooth or WiFi) usable for data exchange.

When operating a home electric appliance (e.g. a TV set, an HD recorder, etc.) by remote control by using a cellular phone terminal having such a function, start, for example, an application for remote control operation to operate a target apparatus according to an operation screen (menu) prepared for the application.

Technique related to a controller which enables remote control of a plurality of apparatuses is recited, for example, in Patent Literature 1, and application of which technique recited in the Patent Literature 1 to a cellular phone terminal also enables remote control operation of a plurality of apparatuses by the cellular phone terminal.

With different patterns of bar codes or light emitting devices whose blinking patterns are different provided in a plurality of apparatuses, the technique recited in the Patent Literature 1 enables remote control of the plurality of apparatuses by reading a bar code pattern or a blinking pattern of the light emitting device by means of a controller to read menu information varying with each apparatus according to the read pattern.
Patent Literature 1: Japanese Patent Laying-Open No. 2001-8279

When operating home electric appliances domestically existing in the plural by remote control by using the infrared communication function or the radio communication function by means of a remote control function installed in a cellular phone terminal, however, it was a common practice to require troublesome operation of, for example, first proceeding from a menu to accessory, remote control operation and selection of the other party's apparatus, having the other party's apparatus selection sub-menu displayed, selecting a home electric appliance of the communication partner from the menu and then selecting an operation screen and operating the other party's apparatus from the operation screen to communicate.

In such a case of data exchange between a cellular phone terminal and a surrounding home electric appliance as a case of proceeding first from a menu, to service, data exchange, home electric appliance liaison and selection of the other party's apparatus, and after selecting the other party's apparatus, watching video on TV which has been taken by a built-in camera and preserved in the cellular phone terminal, it was a common practice to require troublesome operation of first searching for a data storage place to designate target data and searching the menu for operation related to the data to start.

While it is possible to operate a plurality of apparatuses by remote control by using the technique recited in the Patent Literate 1, the technique of the Patent Literature 1 requires a target apparatus to have a bar code or a light emitting device that blinks, which hinders application to remote control operation of home electric appliances which have been already provided and being currently used. Moreover, unlike a dedicated controller, operation of an apparatus by a cellular phone terminal still has such problems as have been already mentioned.

### OBJECT OF THE INVENTION

An object of the present invention is to provide an information terminal apparatus which solves the above-described problems and enables operation appropriate for a target apparatus to be intuitively executed, and operation menu setting method and program thereof.

### SUMMARY

According to a first exemplary aspect of the invention, an information terminal apparatus comprises a target recognition unit which recognizes a target apparatus from an image taken by photographing the apparatus by a built-in camera, a menu management unit which presents operation menu information preserved in advance according to said target apparatus based on a recognition result obtained by said target recognition unit, and a processing unit which gives an operation instruction according to operation contents selected based on said operation menu information.

According to a second exemplary aspect of the invention, an operation method of operating a target apparatus by an information terminal apparatus having a built-in camera, comprising the steps of recognizing a target apparatus from an image taken by photographing the apparatus by the built-in camera, presenting operation menu information preserved in advance according to said target apparatus based on a recognition result of the target, and giving an operation instruction according to operation contents selected based on said operation menu information.

According to a third exemplary aspect of the invention, a program which causes an information terminal apparatus having a built-in camera to execute the processing of recognizing a target apparatus from an image taken by photographing the apparatus by the built-in camera, presenting operation menu information preserved in advance according to said target apparatus based on a recognition result of the target, and giving an operation instruction according to operation contents selected based on said operation menu information.

The present invention enables operation appropriate for a target apparatus to be intuitively executed because an operation menu according to the target apparatus can be presented simply by photographing the target apparatus by a built-in camera.

### BRIEF DESCRIPTION OF THE DRAWINGS

FIG. 1 is a block diagram showing a structure of a cellular phone terminal according to a first exemplary embodiment of the present invention;

FIG. 2 is a diagram showing an example of arrangement of an apparatus operation menu table of an apparatus menu information storage unit according to the first exemplary embodiment;

FIG. 3 is a diagram showing an example of arrangement of a feature pattern and operation menu information to be registered at the apparatus operation menu table of the apparatus menu information storage unit;

FIG. 4 is a flow chart for use in explaining contents of operation menu generation processing of the cellular phone terminal according to the first exemplary embodiment;

FIG. 5 is a flow chart for use in explaining contents of operation processing of a target apparatus by the cellular phone terminal according to the first exemplary embodiment;

FIG. 6 is a diagram showing an example of operation of the cellular phone terminal according to the first exemplary embodiment;

FIG. 7 is a flow chart for use in explaining contents of operation menu generation processing of a cellular phone terminal according to a second exemplary embodiment;

FIG. 8 is a diagram showing an example of arrangement of an apparatus operation menu table of an apparatus menu information storage unit according to the second exemplary embodiment;

FIG. 9 is a flow chart for use in explaining contents of operation processing of a target apparatus by the cellular phone terminal according to the second exemplary embodiment;

FIG. 10 is a diagram showing an example of operation of the cellular phone terminal according to the second exemplary embodiment; and

FIG. 11 is a diagram showing an example of operation of a cellular phone terminal according to a third exemplary embodiment.

### EXEMPLARY EMBODIMENT

Next, exemplary embodiments of the present invention will be detailed with reference to the drawings.

### First Exemplary Embodiment

First, a first exemplary embodiment of the present invention will be detailed with reference to the drawings.

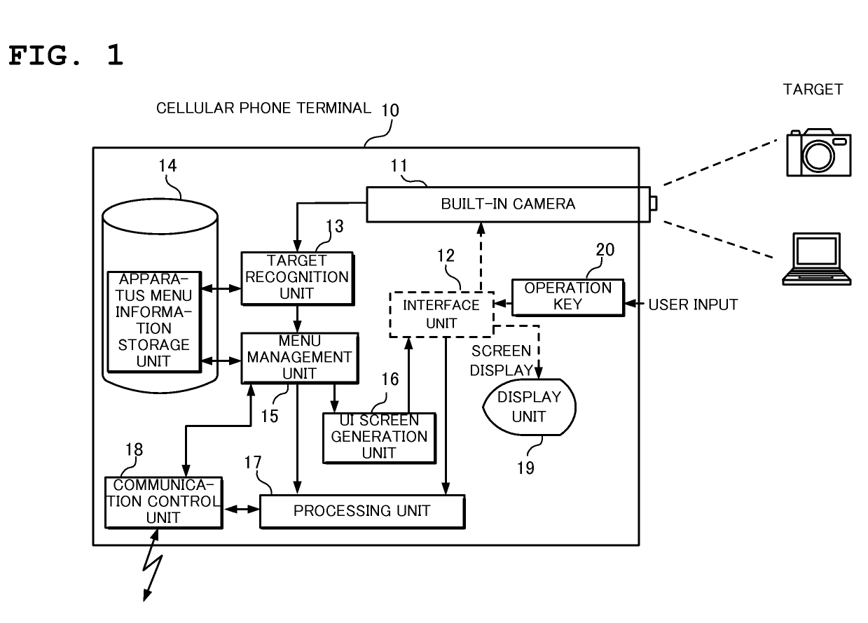

FIG. 1 is a block diagram showing a structure of a cellular phone terminal 10 according to the first exemplary embodiment of the present invention. With reference to FIG. 1, the cellular phone terminal 10 according to the present exemplary embodiment includes a built-in camera 11, an input/output interface unit 12, a target recognition unit 13, an apparatus menu information storage unit 14, a menu management unit 15, an UI (User Interface) screen generation unit 16, a processing unit 17, a communication control unit 18, a display unit 19 and an operation key 20.

In FIG. 1, only components necessary for the present invention are shown but not the other components that a common cellular phone terminal 10 has. Although in the present exemplary embodiment, shown is an example where a cellular phone terminal is used as an information terminal apparatus, also applicable are other information terminal apparatuses with a camera function and a communication function including a smart phone, a PDA, a notebook PC and the like.

The built-in camera 11, similarly to a camera provided in an ordinary cellular phone terminal 10, has a function of taking a still picture or video of a target and preserving its image. To the input/output interface unit 12, the display unit 19 for displaying character information or image information and the operation key 20 for a user to input a character or operation are connected.

The target recognition unit 13 has a function of extracting, from an image of a target apparatus taken by the built-in camera 11, a feature pattern such as a feature point of the target apparatus. The unit also has a function of registering an extracted feature pattern at the apparatus menu information storage unit 14 at initial setting of an operation menu, as well as a function, in actual operation, of collating an extracted feature pattern and a feature pattern registered at the apparatus menu information storage unit 14 to recognize a target apparatus photographed.

The apparatus menu information storage unit 14 stores an apparatus operation menu table which will be described later, as well as storing a feature pattern such as a feature point of a target apparatus extracted by the target recognition unit 13 and operation menu information generated by the menu management unit 15.

The menu management unit 15 has a function of generating, at initial setting, an operation menu according to a target apparatus registered, as well as a function of reading, in operation, operation menu information of a recognized target apparatus from the apparatus menu information storage unit 14.

The UI screen generation unit 16 has a function of generating an operation menu screen operable by a user based on operation menu information read by the menu management unit 15 and causing the display unit 19 to display the generated screen.

The processing unit 17 has a function of transmitting an operation instruction to a target apparatus through the communication control unit 18 according to operation contents selected by a user on the operation menu screen displayed on the display unit 19. The unit has a further function of transmitting and receiving such information as a still picture or video to/from a target apparatus through the communication control unit 18.

The communication control unit 18 has a function of executing wire or wireless communication with a target apparatus. Communication is possible by such a communication means as infrared, wireless LAN (Local Area Network), Bluetooth and PLC (Power Line Communications). Used as a communication protocol in communication with a target apparatus are the DLNA (Digital Living Network Alliance) protocol, the RACP (Remote Appliance Control Protocol) and the like.

With the above-described structure, a user operates the cellular phone terminal 10 to direct a lens of the built-in camera 11 to a target apparatus (e.g. a home electric appliance such as a digital camera, a personal computer, a television set or an HD recorder) and presses a photographing button through the operation key connected to the input/output interface unit 12 to photograph the target apparatus placed before the lens of the built-in camera 11. The taken image is sent to the target recognition unit 13.

The target recognition unit 13 extracts a feature point of a target apparatus from an image taken from the same and collates the feature point with a feature pattern for collation which is stored in advance in the apparatus menu information storage unit 14 to determine similarity between them and recognize which of the apparatuses registered in advance corresponds to the target apparatus.

The menu management unit 15 reads operation menu information for an apparatus recognized by the target recognition unit 13 from the apparatus menu information storage unit 14 and sends the same to the UI screen generation unit 16. The UI screen generation unit 16 generates an operation menu screen based on the operation menu information and displays the same on the display unit 19 through the input/output user interface unit to present the same to a user. This enables the user to select necessary operation contents from the operation menu screen displayed on the display unit 19. Then, the processing unit 17 transmits an operation instruction based on operation contents selected on the operation menu screen to the recognized apparatus through the communication control unit 18. This enables remote control operation of the target apparatus recognized.

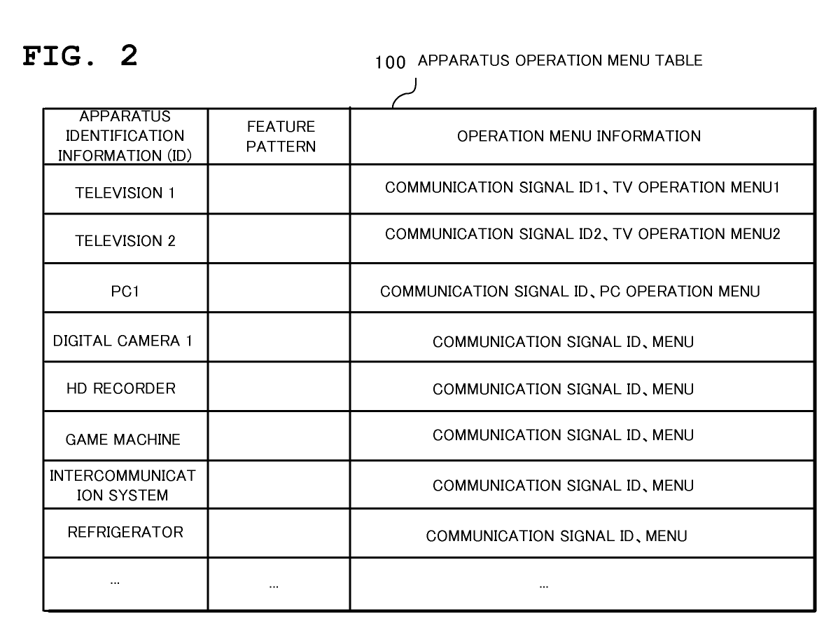

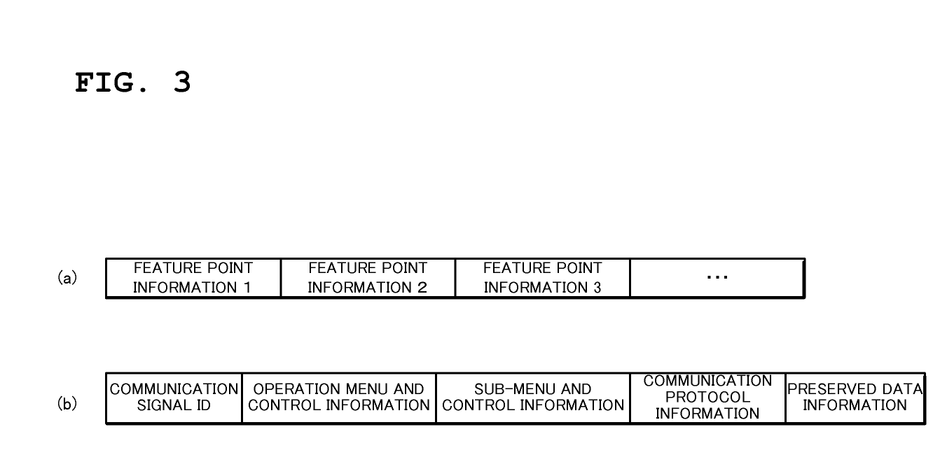

Here, an example of arrangement of an apparatus operation menu table 100 to be stored in the apparatus menu information storage unit 14 is shown in FIG. 2 and FIG. 3.

The apparatus operation menu table 100 registers, for each apparatus to be operated, apparatus identification information (ID), a destination to which a feature pattern is linked and a destination to which operation menu information is linked.

In the apparatus menu information storage unit 14, a feature pattern formed of feature points extracted from an image of each of various kinds of apparatuses domestically used and operation menu information as information about an operation menu and operation contents of the apparatus are preserved in a link destination indicated in the apparatus operation menu table 100.

Feature pattern is formed of one or a plurality of pieces of feature point information as shown in FIG. 3(a) which are prepared, for example, by taking a picture (a plurality of pictures when necessary) of an apparatus such as a home television set or personal computer, or a digital camera and extracting feature point information for recognition from the picture.

The operation menu information includes, as shown in FIG. 3(b), a communication signal ID for identifying a remote control signal for operating a target apparatus, arrangement of an operation menu for the target apparatus and operation control information as of pressing of each button corresponding to the operation menu, arrangement of a submenu under the operation menu and its operation control information when necessary, communication protocol information for use in data exchange, and information related to preservation positions at both sides of data exchanged by the menu operation, specification, etc. Data related to the operation menu information is preserved in a link destination indicated in the apparatus operation menu table 100.

Operation menu information is prepared by downloading, based on information about a manufacturer name of a target apparatus or a model number of the apparatus, from a Web server of the manufacturer via the Internet at initial setting.

### (Description of Operation of First Exemplary Embodiment)

Detailed description will be made of operation of the cellular phone terminal 10 according to the present exemplary embodiment.

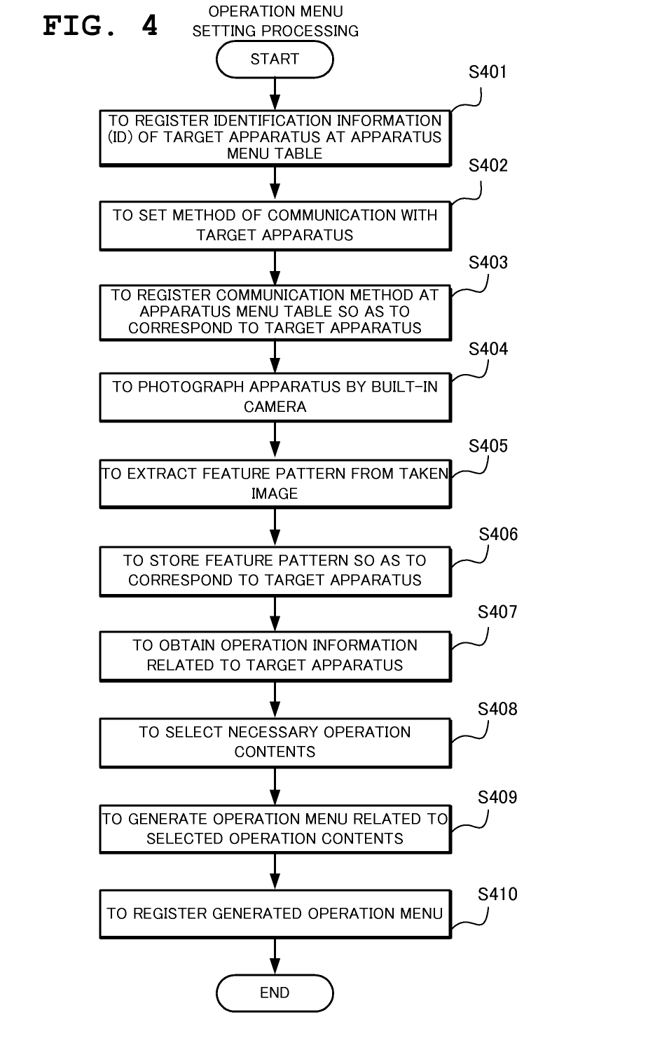

First, description will be made of operation of processing for setting an operation menu of a target apparatus as initial setting with reference to the flow chart of FIG. 4.

First, register apparatus identification information (ID) of a target apparatus to be operated (e.g. a TV set in a living room) at the apparatus operation menu table 100 of the apparatus menu information storage unit 14 (Step S401). The apparatus identification information (ID) can be input by reading a QR code or a bar code of the target apparatus by means of the built-in camera 11 or directly reading the same from internal information of the target apparatus through communication with the target apparatus. User may manually input the information through the operation key 20.

Next, set a communication method (a communication means and a communication protocol) between the cellular phone terminal 10 and the target apparatus (Step S402). As the communication method, a communication method enabling communication with the target apparatus will be selected and set from among communication methods executable by the cellular phone terminal 10.

When using a wireless LAN as a communication means, for example, select the DLNA protocol or the like as a communication protocol. As other communication method, infrared may be selected as a communication means and the IrDA or IrSimple protocol as a communication protocol. As to a communication method, other usable communication methods can be selected as well.

Register a communication signal ID for the communication with the target apparatus according to the communication protocol of the set communication method as operation menu information corresponding to the target apparatus in the apparatus operation menu table 100 (Step S403).

Next, photograph the target apparatus by the built-in camera 11 (Step S404). In photographing the target apparatus, take one or a plurality of pictures of a front part or the like of the target apparatus where its feature appears and send the taken image to the target recognition unit 13.

The target recognition unit 13 analyzes the taken image of the apparatus by using an ER search technique or other and extracts a characteristic part (feature point: e.g. configuration, tone of color or the like of the front part of the apparatus) of the target apparatus from the image as a feature pattern (Step S405) to store the extracted feature pattern in the apparatus menu information storage unit 14, as well as registering a link destination of the feature pattern so as to correspond to the target apparatus in the apparatus operation menu table 100 (Step S406).

Next, obtain operation information required for operating the target apparatus (Step S407).

Acquisition of the operation information may be realized by executing direct communication with the target apparatus to read internal operation information in the target apparatus or by accessing a Web server of a manufacturer of the target apparatus to download the operation information via the Internet.

When no operation information can be obtained from the target apparatus or the server, input the operation information manually by a user while referring to a manual of the target apparatus or the like. In this case, a remote control code recited in the manual can be used as the operation information.

Select operation contents necessary for the operation of the target apparatus from the obtained operation information (Step S408). The selection of the operation contents is executed by presenting the operation contents included in the operation information obtained by the menu management unit 15 to a user through the display unit 19 and making an inquiry.

The user selects operation contents assumed to be required for him/her from among the operation contents displayed on the display unit 19. When the target apparatus is an HD recorder, for example, select such operation contents as power on/off, selection, reproduction, stop, forward-feeding and backward-feeding, etc. of the contents to be reproduced among the operation contents. When the target apparatus is adapted to the DLNA protocol, such operation contents can be also selected as transmission of contents already recorded in the target apparatus to the cellular phone terminal 10.

Next, the menu management unit 15 generates an operation menu based on the operation contents selected by the user (Step S409) to store data of the generated operation menu in the apparatus menu information storage unit 14, as well as registering a link destination of the data of the operation menu at the column of the operation menu information in the apparatus operation menu table 100 (Step S410).

Processing of setting an operation menu for each target apparatus is realized by repeating the above-described procedure starting at Step S401 with respect to a plurality of target apparatuses to be operated by the cellular phone terminal 10.

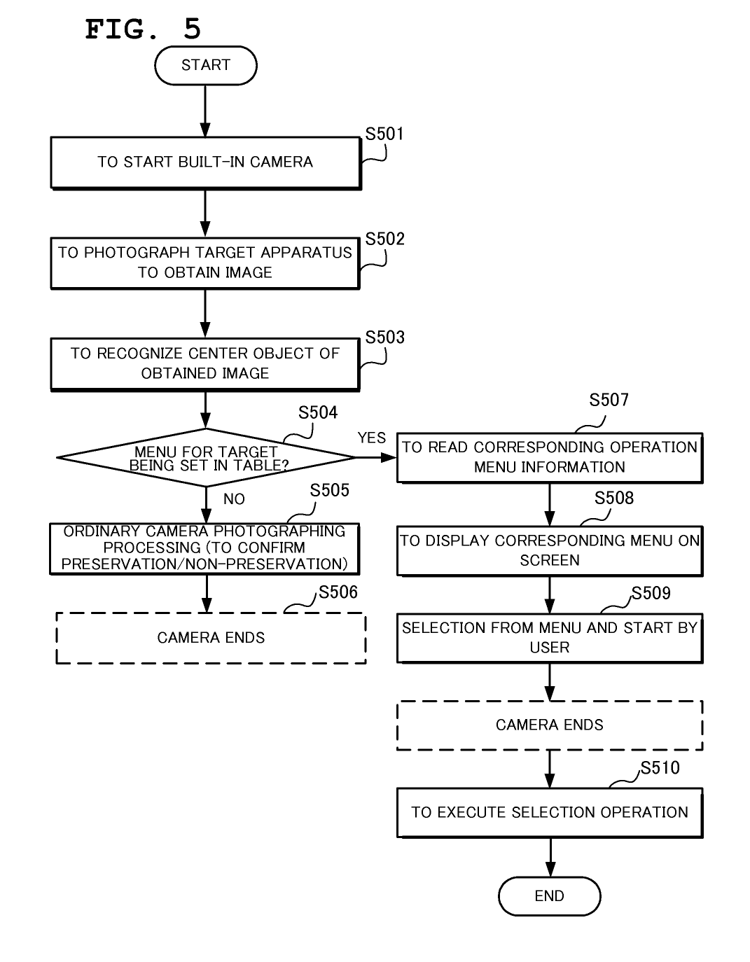

Next, detailed description will be made of operation to be executed when a target apparatus is operated by the cellular phone terminal 10 with reference to the flow chart of FIG. 5.

The user starts the built-in camera 11 of the cellular phone terminal 10 (Step S501) to take a picture directed to a target apparatus (e.g. a TV set in a living room) (Step S502). On this occasion, a picture is taken by pressing an ordinary photographing button or operating a button not common which is prepared for this purpose (e.g. menu button). The taken image is transferred to the target recognition unit 13.

Next, the target recognition unit 13 extracts a feature pattern from the taken image and collates the extracted feature pattern with a feature pattern read from the apparatus menu information storage unit 14 to execute recognition processing of finding whether the photographed target apparatus is an apparatus registered at the apparatus operation menu table 100 (Step S503).

As a result of the recognition processing, when the target apparatus is not registered at the apparatus operation menu table 100 of the apparatus menu information storage unit 14 (NO at Step S504), execute such processing of confirming preservation of the image to the user and preserving the image as ordinary camera photographing processing (Step S505, Step S506).

It is also possible to execute target apparatus recognition processing with the built-in camera 11 directed to the target apparatus with the display unit 19 displaying video of the target apparatus, without executing operation of taking an image of the target apparatus by the operation of the photographing button or the menu button.

As a result of the recognition processing, when the target apparatus is registered at the apparatus operation menu table 100 of the apparatus menu information storage unit 14 (YES at Step S504), the menu management unit 15 reads operation menu information of the corresponding target apparatus (e.g. a TV set in a living room) from the apparatus operation menu table 100 (Step S507) and sends a communication signal ID indicated in the operation menu information to the processing unit 17 and data of the operation menu to the UI screen generation unit 16.

The UI screen generation unit 16 generates an operation menu screen operable by the user based on the data of the operation menu and causes the display unit 19 to display the same (Step S508).

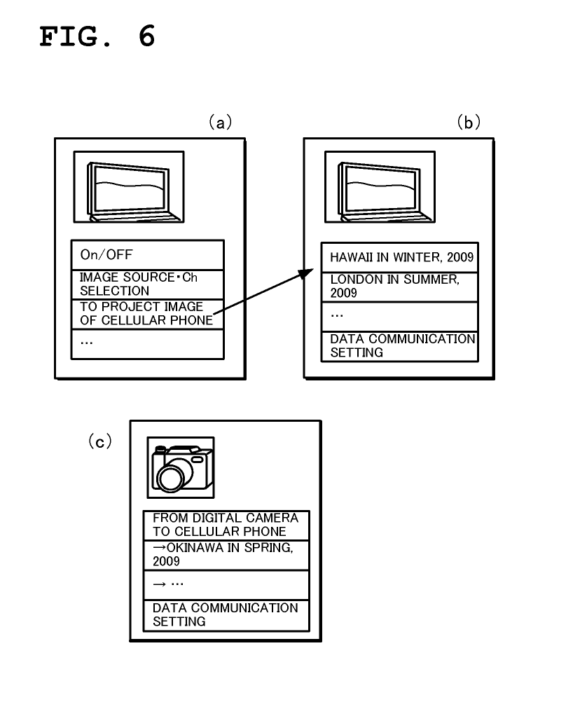

FIG. 6 shows an example of an operation menu screen displayed on the display unit 19 at Step S508. FIG. 6(a) shows an example of an operation menu screen in a case where the target apparatus is a TV set and FIG. 6(b) shows an example of a sub-menu screen for data selection or data communication setting which is to be displayed when on the operation menu screen, the operation contents are selected for showing video of the cellular phone terminal 10 on the TV set.

Here, when the user selects the operation contents from the operation menu screen (Step S509), an operation instruction according to the selected operation contents is transmitted from the communication control unit 18 to the target apparatus (Step S510). As a result, remote control operation of the target apparatus is executed.

When video of Hawaii is selected in data selection on the menu screen shown in FIG. 6(b), for example, the selected video in the cellular phone terminal 10 is sent to the TV set by a communication method set in advance, for example, by such a protocol as DLNA through WiFi of a wireless LAN and reproduced thereon. While FIG. 6(b) shows the menu up to designation of a folder, also as to its subordinate individual image and video files, a menu to be selected will be presented by displaying of a thumbnail or the like.

By the same method, remote control operation of a personal computer, a digital camera and an HD recorder, data exchange (including sending data of the personal computer or the digital camera to the cellular phone terminal 10 and viewing the same by the cellular phone) and response to an intercommunication system can be realized by remote control. FIG. 6(c) shows an example of an operation menu screen in a case of a target apparatus being a digital camera where data in the digital camera is shown in a list, transferred therefrom to the cellular phone terminal 10 for viewing.

### (Effects of the First Exemplary Embodiment)

Next, effects of the first exemplary embodiment will be described.

According to the present exemplary embodiment, simply photographing a target apparatus such as a home electric appliance domestically existing in the plural by the built-in camera 11 enables remote control operation by the cellular phone terminal 10. When operating a home electric appliance or the like by remote control by using the cellular phone terminal 10, it has been troublesome to search a menu prepared in the cellular phone terminal 10 for a remote control function and start the function to execute remote control operation. According to the present exemplary embodiment, just by directing a built-in camera to a target apparatus, an operation menu will be presented according to the target apparatus, which makes remote control operation very easy.

In addition, selecting operation contents required by a user and registering them as an operation menu for each of various kinds of apparatuses enables intuitive operation easy to understand. In a case, for example, of data exchange with a surrounding home electric appliance, preferentially selecting operation contents related to the data exchange and registering the same as an operation menu makes apparatus operation very easy.

As described in the foregoing, while operation by the cellular phone terminal 10 has been so far realized mainly by procedures, the present exemplary embodiment realizes an object-oriented operation system in which according to a recognized target object, operation (method) related to the object can be selected.

### Second Exemplary Embodiment

Second exemplary embodiment of the present invention will be described in detail with reference to the drawings.

In the first exemplary embodiment, photographing a target apparatus by the built-in camera 11 to recognize the same and presenting an operation menu set in advance for each apparatus to the cellular phone terminal 10 enable remote control operation of the target apparatus from the operation menu. In contrast, the second exemplary embodiment enables recognition of a target apparatus and its current operation state and presentation of an appropriate operation menu according to the operation state.

Since a structure of the cellular phone terminal 10 according to the second exemplary embodiment is the same as that of the first exemplary embodiment shown in FIG. 1, no description will be made thereof.

In the second exemplary embodiment, at the time of setting an operation menu at initial setting, pictures of the respective operation states of a target apparatus (e.g. a power-off state, a power-on state, a video reproduction state, a video recording state, etc. in a case of an HD recorder) are taken by the built-in camera 11, and a feature pattern is extracted from their images on an operation state basis and registered at the apparatus menu information storage unit 14. In addition, desired operation contents are selected on an operation state basis and registered at the apparatus operation menu table 100 as operation menu information.

In a case, for example, of a power-on or power-off state, which can be recognized by color or a position of a pilot lamp, a screen state or the like, registering a feature pattern according to each of these states enables a current operation state of the target apparatus to be recognized.

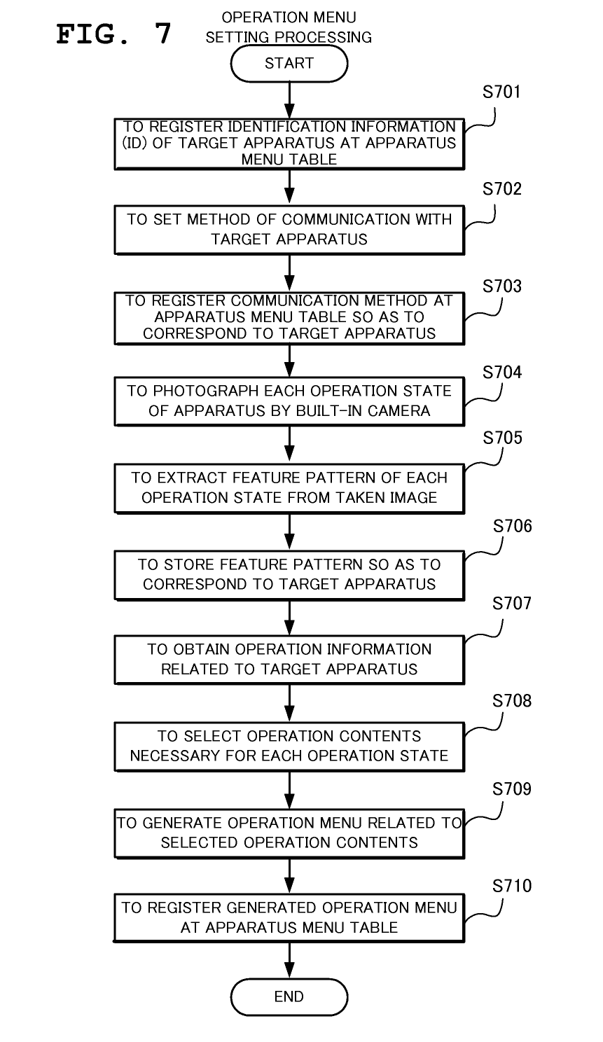

First, description will be made of operation of processing for setting an operation menu of a target apparatus as initial setting with reference to the flow chart of FIG. 7.

Since Steps S701 to S703, Step S707, Step S709 and Step S710 shown in FIG. 7 have the same processing as that of Steps S401 to S403, Step S407, Step S409 and Step S410 shown in FIG. 4, processing contents of Step S704 to Step S706, and Step S708 which are different from those of the first exemplary embodiment will be described in the following.

When photographing a target apparatus by the built-in camera 11 at Step S704, with respect to each operation state of the target apparatus, take one or a plurality of pictures of the apparatus at a state which enables identification of its operation state and send the taken image to the target recognition unit 13 in the present exemplary embodiment.

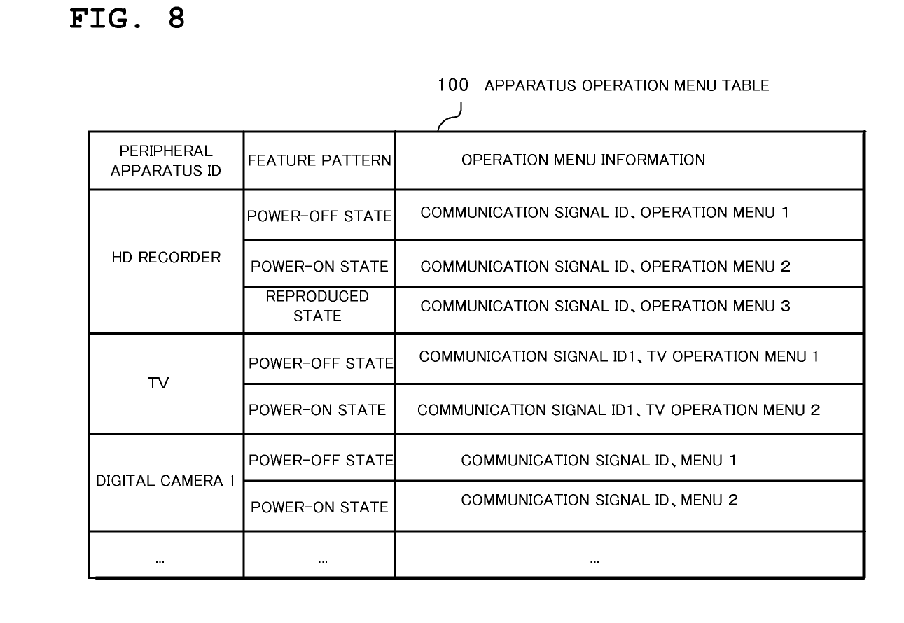

At Step S705, the target recognition unit 13 analyzes the taken image of the apparatus by using an ER search technique or other and extracts a characteristic part (feature point: e.g. configuration, tone of color or the like of the front part of the apparatus) of the target apparatus from the image as a feature pattern to store the feature pattern extracted at each operation state in the apparatus menu information storage unit 14. Then, at Step S706, register a link destination of the feature pattern so as to correspond to an operation state of the target apparatus in the apparatus operation menu table 100 as shown in FIG. 8.

In the example of the apparatus operation menu table 100 shown in FIG. 8, a feature pattern is registered according to an operation state (power-off state, power-on state, reproduction state) of the target apparatus.

At Step S708 where from the obtained operation information, operation contents necessary for the operation of the target apparatus are selected, a user selects operation contents assumed to be necessary for him/her on a target apparatus operation state basis in the present exemplary embodiment. In a power-off state of an HD recorder, for example, select operation of power-on and further select contents of operation to be subsequently executed among operation contents. In a power-on state, first select operation of selecting contents to be reproduced and then select contents of operation to be subsequently executed (reproduction, stop, etc.).

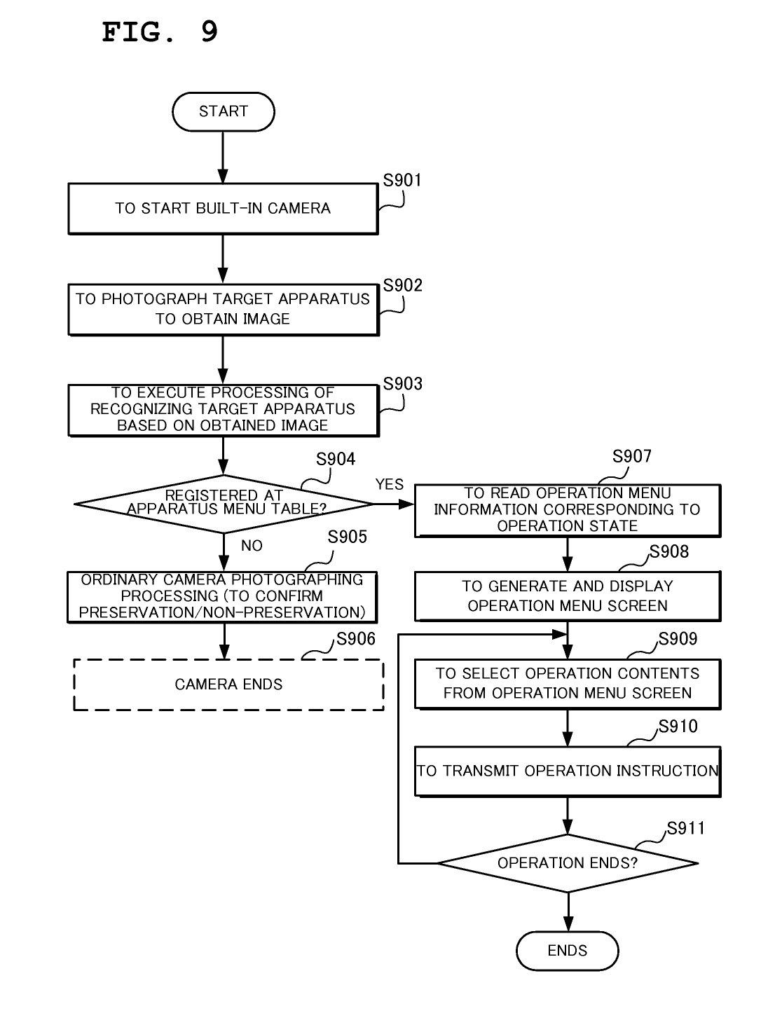

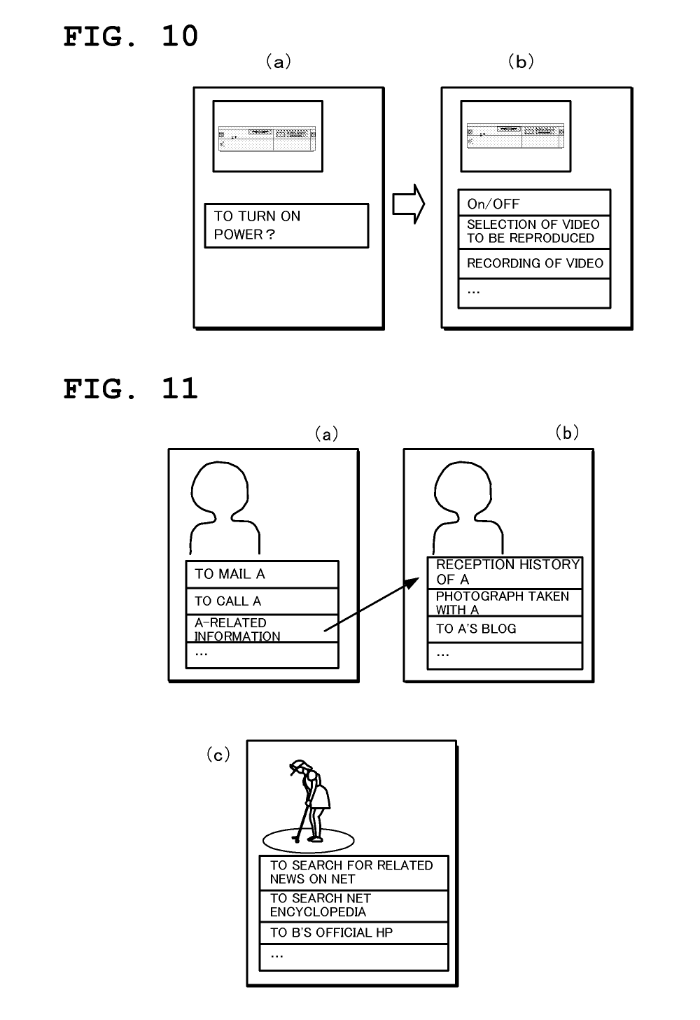

In the power-off state of the HD recorder, it is possible, for example, to set contents of operation to directly proceed to power-on operation. With such an operation menu set, when the HD recorder is photographed by the built-in camera 11 to recognize that the HD recorder is in the power-off state, a menu screen inquiring about power-on of the HD recorder as shown in FIG. 9(a) is first presented and then, contents of operation to be subsequently executed as shown in FIG. 9(b) are presented as a menu screen. This eliminates user's need of executing operation after confirming a state of the HD recorder, thereby enabling appropriate operation according to a state to be executed quickly.

With reference to the flow chart shown in FIG. 9, detailed description will be made of operation executed when a target apparatus is operated by the cellular phone terminal 10.

Since Steps S901, S902, S904 to S906, and Step S908 to Step S911 shown in FIG. 9 have the same processing as that of Steps S501, S502, Step S504 to S506, and Step S508 to Step S511 shown in FIG. 5, processing contents of Steps S903 and S907 which are different from those of the first exemplary embodiment will be described in the following.

In the processing of recognizing a target apparatus at Step S903 in FIG. 9, by extracting a feature pattern from an obtained image and collating the extracted feature pattern with a feature pattern read from the apparatus menu information storage unit 14, the target recognition unit 13 determines whether the target apparatus photographed is registered at the apparatus operation menu table 100 and recognizes to which of operation states registered at the apparatus operation menu table 100 the operation state of the target apparatus corresponds.

At Step S907, the menu management unit 15 reads an operation menu according to the recognized operation state from the apparatus operation menu table 100 and sends data of the operation menu to the UI screen generation unit 16.

In initial setting, operation contents are selected for each operation state, in which operation contents for direct operation of the apparatus can be selected. When the target apparatus is in the power-off state, for example, it is also possible to transmit a power-on operation instruction to the target apparatus to bring the apparatus into the power-on state and then display a menu screen for the operation of the target apparatus without displaying a menu screen inquiring about turning-on of power.

### (Effects of the Second Exemplary Embodiment)

Next, effects of the second exemplary embodiment will be described.

In addition to the effect attained by the first exemplary embodiment, since in a case of recognizing a target apparatus to present an operation menu for operating the apparatus to a user, an appropriate operation menu is presented according to an operation state of the target apparatus, the present exemplary embodiment enables more comfortable operation when operating the target apparatus by using the cellular phone terminal 10.

### Third Exemplary Embodiment

While in the first exemplary embodiment, a home electric appliance is targeted, in the present exemplary embodiment, description will be made of a case where a person is targeted. Since a structure of the cellular phone terminal 10 according to the third exemplary embodiment is also the same as that of the first exemplary embodiment shown in FIG. 1, no description will be made thereof.

For example, photograph A, a friend who you have met in town or photograph a picture of A to recognize that she is your friend A who has been registered in advance, and call up and set a menu which enables operation related to your friend A to enable processing to be executed according to the operation in question.

Since in the present exemplary embodiment, a target apparatus in the above-described exemplary embodiments is simply replaced by a target person, the operation of registering a feature pattern of each target person and further registering necessary operation contents at the menu table as a menu at initial setting is the same as that of the first exemplary embodiment.

It is also the same as that of the first exemplary embodiment to recognize a target person from an image taken from the target person by the built-in camera 11 and present its corresponding operation menu. One to which an operation instruction is given after selecting operation contents from an operation menu, however, is not a target apparatus but the cellular phone terminal 10 itself.

Operation example is shown in FIG. 11. FIG. 11(a) shows an example of a menu to be presented when the friend A is photographed and recognized. FIG. 11(b) shows an example of a sub-menu to be presented when “information related to the friend A” is selected from the menu shown in FIG. 11(a).

When mail or telephone is selected from the menu in FIG. 11(a), for example, read data of the friend A from telephone directory data to execute corresponding processing. On the menu shown in FIG. 11(b), A-related data is extracted from the internally preserved data and displayed, and connection is made from URL registered in advance to a personal page or a blog of the friend A.

In a case where your favorite celebrity B appears on TV, when taking a picture of a screen of the TV set, the celebrity B is recognized from the taken image to present such an operation menu registered in advance related to the celebrity B as shown in FIG. 11(c) by the same manner. Selection of operation contents from the operation menu enables Internet search for information about the celebrity B to collect related information.

Thus enables object-oriented intuitive operation easy to understand also with respect to a person.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INCORPORATION BY REFERENCE

This application is based upon and claims the benefit of priority from Japanese patent application No. 2010-008391, filed on Jan. 18, 2010, the disclosure of which is incorporated herein in its entirety by reference.

### INDUSTRIAL APPLICABILITY

The present invention is applicable to portable information terminal apparatuses in general including a cellular phone terminal which have a camera function and a communication function such as a smart telephone, a PDA and a notebook personal computer.

1. An information terminal apparatus comprising:
a target recognition unit which recognizes a target apparatus from an image taken by photographing the apparatus by a built-in camera;
a menu management unit which presents operation menu information preserved in advance according to said target apparatus based on a recognition result obtained by said target recognition unit; and
a processing unit which gives an operation instruction according to operation contents selected based on said operation menu information.

2. The information terminal apparatus according to claim 1, further comprising:
a target menu information storage unit in which a feature pattern on an image of said target apparatus and operation menu information including operation contents selected in advance according to the target apparatus are registered for each said target apparatus, wherein
said target recognition unit collates a feature pattern extracted from said image taken and a feature pattern in said target menu information storage unit to recognize said target apparatus, and
said menu management unit reads the operation menu information corresponding to said target apparatus recognized from said target menu information storage unit and presents the read information.

3. The information terminal apparatus according to claim 2, wherein
in said target menu information storage unit, a table is stored in which information which identifies said target apparatus, a link destination of a feature pattern of said target apparatus and a link destination of the operation menu information according to said target apparatus are registered for each said target apparatus,
said target recognition unit collates a pattern extracted from a taken image and a feature pattern registered at said table to determine whether said target apparatus is registered at the table or not, and
when said target apparatus is registered at the table, said menu management unit reads the operation menu information registered so as to correspond to the target apparatus in said table from said target menu information storage unit and presents the read information.

4. The information terminal apparatus according to claim 2, wherein
a feature pattern of each operation state of said target apparatus and the operation menu information including operation contents appropriate for the operation state are stored in said target menu information storage unit,
said target recognition unit collates a feature pattern extracted from said image taken and a feature pattern in said target menu information storage unit to recognize an operation state of said target apparatus, and
said menu management unit reads the operation menu information corresponding to an operation state of said target apparatus recognized from said target menu information storage unit and presents the read information.

5. The information terminal apparatus according to of claim 1, wherein
said operation menu information includes protocol information for the communication with said target apparatus.

6. An operation method of operating a target apparatus by an information terminal apparatus having a built-in camera, comprising the steps of:
recognizing a target apparatus from an image taken by photographing the apparatus by the built-in camera;
presenting operation menu information preserved in advance according to said target apparatus based on a recognition result of the target; and
giving an operation instruction according to operation contents selected based on said operation menu information.

7. The operation method by an information terminal apparatus according to claim 6, further comprising the steps of:
registering, for each said target apparatus, a feature pattern on an image of said target apparatus and operation menu information including operation contents selected in advance according to the target apparatus at a target menu information storage unit,
at said target recognition step, collating a feature pattern extracted from said image taken and a feature pattern in said target menu information storage unit to recognize said target apparatus, and
at said menu presenting step, reading the operation menu information corresponding to said target apparatus recognized from said target menu information storage unit and presenting the read information.

8. The operation method by an information terminal apparatus according to claim 7, comprising the steps of:
in said target menu information storage unit, storing a table in which information which identifies said target apparatus, a link destination of a feature pattern of said target apparatus and a link destination of the operation menu information according to said target apparatus are registered for each said target apparatus,
at said target recognition step, collating the pattern extracted from the taken image and a feature pattern registered at said table to determine whether said target apparatus is registered at the table or not, and
at said menu presenting step, when said target apparatus is registered at the table, reading the operation menu information registered so as to correspond to the target apparatus in said table from said target menu information storage unit and presenting the read information.

9. The operation method by an information terminal apparatus according to claim 7, comprising the steps of:
in said target menu information storage unit, storing a feature pattern of each operation state of said target apparatus and the operation menu information including operation contents appropriate for the operation state,
at said target recognition step, collating a feature pattern extracted from said image taken and a feature pattern in said target menu information storage unit to recognize the operation state of said target apparatus, and
at said menu presenting step, reading the operation menu information corresponding to the operation state of said target apparatus recognized from said target menu information storage unit and presenting the read information.

10. The operation method by an information terminal apparatus according to claim 6, wherein
said operation contents include protocol information for the communication with said target apparatus.

11. A computer-readable medium storing a program, wherein said program causes an information terminal apparatus having a built-in camera to execute the processing of:
recognizing a target apparatus from an image taken by photographing the apparatus by the built-in camera;
presenting operation menu information preserved in advance according to said target apparatus based on a recognition result of the target; and
giving an operation instruction according to operation contents selected based on said operation menu information.

12. The information terminal apparatus according to claim 3, wherein
a feature pattern of each operation state of said target apparatus and the operation menu information including operation contents appropriate for the operation state are stored in said target menu information storage unit,
said target recognition unit collates a feature pattern extracted from said image taken and a feature pattern in said target menu information storage unit to recognize an operation state of said target apparatus, and
said menu management unit reads the operation menu information corresponding to an operation state of said target apparatus recognized from said target menu information storage unit and presents the read information.

13. The information terminal apparatus according to of claim 2, wherein
said operation menu information includes protocol information for the communication with said target apparatus.

14. The information terminal apparatus according to of claim 3, wherein
said operation menu information includes protocol information for the communication with said target apparatus.

15. The information terminal apparatus according to of claim 4, wherein
said operation menu information includes protocol information for the communication with said target apparatus.

16. The operation method by an information terminal apparatus according to claim 8, comprising the steps of:
in said target menu information storage unit, storing a feature pattern of each operation state of said target apparatus and the operation menu information including operation contents appropriate for the operation state,
at said target recognition step, collating a feature pattern extracted from said image taken and a feature pattern in said target menu information storage unit to recognize the operation state of said target apparatus, and
at said menu presenting step, reading the operation menu information corresponding to the operation state of said target apparatus recognized from said target menu information storage unit and presenting the read information.

17. The operation method by an information terminal apparatus according to claim 7, wherein
said operation contents include protocol information for the communication with said target apparatus.

18. The operation method by an information terminal apparatus according to claim 8, wherein
said operation contents include protocol information for the communication with said target apparatus.

19. The operation method by an information terminal apparatus according to claim 9, wherein
said operation contents include protocol information for the communication with said target apparatus.
